(19) United States
(12) Patent Application Publication
(10) Pub. No.: US 2023/0090726 A1
(43) Pub. Date: Mar. 23, 2023

(54) APPARATUS AND METHOD FOR HARDWARE-BASED RANDOM NUMBER AND SEQUENCE OF NUMBERS GENERATION

(71) Applicants: Fraunhofer-Gesellschaft zur Foerderung der angewandten Forschung e.V., Munich (DE); Universitaet Stuttgart, Stuttgart (DE)

(72) Inventors: Nan DU, Chemnitz (DE); Heidemarie SCHMIDT, Chemnitz (DE); Stefan SCHULZ, Chemnitz (DE); Ilia POLIAN, Stuttgart (DE); Zhao XIANYUE, Chemnitz (DE)

(21) Appl. No.: 18/059,530

(22) Filed: Nov. 29, 2022

Related U.S. Application Data
(63) Continuation of application No. PCT/EP2021/064222, filed on May 27, 2021.

(30) Foreign Application Priority Data
May 29, 2020 (DE) 102020206790.2

(51) Int. Cl. G06F 7/58

(52) U.S. Cl. CPC G06F 7/588

(57) ABSTRACT

An apparatus for generating a sequence of random numbers has a switchable element switchable to a first state by applying a first bias voltage, and to a second state by applying a different, second bias voltage, configured, when switched to the first state, to output a first output voltage having a first random or pseudorandom voltage value, and, when switched to the second state, to output a second output voltage, further having a comparator configured to output, if the first output voltage is smaller than or equal to a first threshold voltage, a first numerical value, and to output, if the first output voltage is greater than the first threshold voltage, a different, second numerical value. Furthermore, if the second output voltage is smaller than or equal to a second threshold voltage, the comparator is configured to output the first numerical value, and if the second output voltage is greater than the second threshold voltage, to output the second numerical value, or vice versa.

### CROSS-REFERENCE TO RELATED APPLICATIONS

This application is a continuation of copending International Application No. PCT/EP2021/064222, filed May 27, 2021, which is incorporated herein by reference in its entirety, and additionally claims priority from German Application No. 102020206790.2, filed May 29, 2020, which is also incorporated herein by reference in its entirety.

### TECHNICAL FIELD

The application relates to an apparatus and a method for hardware-based true random number and sequence of numbers generation and, in particular, to an apparatus for hardware-based random number generators (RNG) and its operation, in particular, to an apparatus for hardware-based random number generators (RNG) with electroforming-free memristors. Furthermore, the application relates, in particular, to the setup of the electronic circuit and a method for operating the RNG as a true random number generator (TRNG) and as a sequence of numbers generator (SNG).

### BACKGROUND OF THE INVENTION

Advances in energy- and cost-efficient computing and wireless connectivity have led to the Internet of Things (IoT). The IoT is a major drive for scientific, technological, economic, and social progress, and 50.1 billion IoT devices are expected to be in use by 2020, see [1].

Stochastic computing (SC) with a stochastic number generator (SNG) is a computing paradigm which offers extremely compact, energy-efficient and fault-tolerant realizations of certain functions at the cost of lower precision and longer computation time. These unconventional features make it an interesting choice for IoT applications such as area monitoring or environmental monitoring.

TRNGs rely on intrinsic stochasticity in physical variables of the system. It has been shown that TRNGs can be implemented electronically based on silicon CMOS technology. A large number of TRNGs are suitable for manufacturing on an ASIC silicon process or for an implementation on reconfigurable logic platforms, e.g., FPGA (field programmable gate array) or CPLD (complex programmable logic device). The entropy sources of such designs are, for example, thermal noise due to oscillator jitter [2], resistor amplifier analog-to-digital converter chains (see [3]), or metastable elements with capacitive feedback (see [4]).

The first memristive TRNG was proposed in 2010, see [5]. The read instability in many memristive devices due to random telegraph noise (RTN) can be used as a source of entropy for TRNG, e.g., RTN from the LRS of a W/TiN/TiON/SiO₂/Si memristor [6]. These circuits are difficult to activate and control because the applied voltages strongly depend on the probabilities “0” and “1”. Recently, it was also proved that RTN is randomly activated or deactivated without predictability (see [7]).

Balatti et al. proposed a TRNG which is based on the cycle-to-cycle and device-to-device voltage variations of Cu/AlOx- and Ti/HfOx-based memristors (see [8], [9]). This memristor-based TRNG also entails careful tuning of the applied voltage/current flow to realize a predetermined probability distribution. In addition, an SET-RESET pulse pair is always used to generate each random bit since the memory elements are non-volatile. In addition, none of the TRNGs mentioned before can pass all the standard statistical test packages developed by the National Institute of Standards and Technology (NIST 800-22 Test Suite) (see [10]), even if the data is post-processed.

Wei et al. have realized a TRNG with random numbers from small read current variations at certain resistance states in TaOx-based memristors [11]. Again, complicated algorithms and circuitry are used to ensure the stochasticity of the generated binary bits before they can pass the NIST tests.

Stochastic computing (SC) has been considered to be a promising alternative to conventional deterministic computing. SC processes data in a probabilistic approach and handles computational uncertainties more effectively and efficiently (see [12]) with high fault tolerance, which meets the key requirement for future nanotechnology. According to the working principle of SC, the degree of accuracy of SC is subject to the randomness of stochastic bit streams. For this purpose, a sequence of numbers generator (SNG) with a controlled adjustable probability of 0/1 bit streams is used. In conventional CMOS approaches, a silicon technology-based stochastic number generator (SNG) is used to generate 0/1 bit streams of predetermined probability. These SNGs account for a large part of the resource consumption in SC with costs of up to 80% of the entire system from [12].

### SUMMARY

According to an embodiment, an apparatus for generating a sequence of random numbers may have: a switchable element switchable to a first state by applying a first bias voltage, and switchable to a second state by applying a second bias voltage different from the first bias voltage; wherein the switchable element is configured, when switched to the first state by the first bias voltage, to output a first output voltage having a first random or pseudorandom voltage value from a first range of voltage values and wherein the switchable element is configured, when switched to the second state by the second bias voltage, to output a second output voltage having a second random or pseudorandom voltage value from a second range of voltage values; and a comparator configured to output, if the first output voltage from the first range of values is smaller than or equal to a first threshold voltage, a first numerical value; and output, if the first output voltage from the first range of values is greater than the first threshold voltage, a second numerical value different from the first numerical value; wherein the comparator is configured, if the second output voltage from the second range of value is smaller than or equal to a second threshold voltage, to output the first numerical value, and if the second output voltage from the second range of values is greater than the second threshold voltage, to output the second numerical value; or if the second output voltage from the second range of values is smaller than or equal to a second threshold voltage, to output the second numerical value, and if the second output voltage from the second range of values is greater than the second threshold voltage, to output the first numerical value.

According to another embodiment, a method for generating a sequence of random numbers may have the steps of: applying a first bias voltage to a switchable element to switch the switchable element to a first state, or applying a second bias voltage, different from the first bias voltage, to the switchable element to switch the switchable element to a second state; wherein the switchable element is configured, when switched to the first state by the first bias voltage, to output a first output voltage having a first random or pseudorandom voltage value from a first range of voltage values; and wherein the switchable element is configured, when switched to the second state by the second bias voltage, to output a second output voltage having a second random or pseudorandom voltage value from a second range of voltage values; and outputting a first numerical value if the first output voltage from the first range of values is smaller than or equal to a first threshold voltage; or outputting a second numerical value, different from the first numerical value, if the first output voltage from the first range of values is greater than the first threshold voltage; or outputting the second numerical value if the first output voltage from the first range of values is smaller than or equal to a first threshold voltage; or outputting the first numerical value if the first output voltage from the first range of values is greater than the first threshold voltage.

Another embodiment may have a non-transitory digital storage medium having stored thereon a computer program for performing a method for generating a sequence of random numbers, the method having the steps of: applying a first bias voltage to a switchable element to switch the switchable element to a first state, or applying a second bias voltage, different from the first bias voltage, to the switchable element to switch the switchable element to a second state; wherein the switchable element is configured, when switched to the first state by the first bias voltage, to output a first output voltage having a first random or pseudorandom voltage value from a first range of voltage values; and wherein the switchable element is configured, when switched to the second state by the second bias voltage, to output a second output voltage having a second random or pseudorandom voltage value from a second range of voltage values; and outputting a first numerical value if the first output voltage from the first range of values is smaller than or equal to a first threshold voltage; or outputting a second numerical value, different from the first numerical value, if the first output voltage from the first range of values is greater than the first threshold voltage; or outputting the second numerical value if the first output voltage from the first range of values is smaller than or equal to a first threshold voltage; or outputting the first numerical value if the first output voltage from the first range of values is greater than the first threshold voltage, when said computer program is run by a computer

An apparatus for generating a sequence of random numbers according to an embodiment is provided. The apparatus comprises a switchable element switchable to a first state by applying a first bias voltage, and switchable to a second state by applying a second bias voltage different from the first bias voltage. The switchable element is configured, when switched to the first state by the first bias voltage, to output a first output voltage having a first random or pseudorandom voltage value from a first range of voltage values. Furthermore, when switched to the second state by the second bias voltage, the switchable element is configured to output a second output voltage having a second random or pseudorandom voltage value from a second range of voltage values. Furthermore, the apparatus comprises a comparator configured to output, if the first output voltage from the first range of values is smaller than or equal to a first threshold voltage, a first numerical value; and to output, if the first output voltage from the first range of values is greater than the first threshold voltage, a second numerical value different from the first numerical value. Additionally, if the second output voltage from the second range of values is smaller than or equal to a second threshold voltage, the comparator is configured to output the first numerical value, and if the second output voltage from the second range of values is greater than the second threshold voltage, to output the second numerical value. Or else the comparator is configured to output the second numerical value if the second output voltage from the second range of values is smaller than or equal to a second threshold voltage, and to output the first numerical value if the second output voltage from the second range of values is greater than the second threshold voltage.

Furthermore, a method for generating a sequence of random numbers according to an embodiment is provided. The method comprises:
applying a first bias voltage to a switchable element to switch the switchable element to a first state, or applying a second bias voltage, different from the first bias voltage, to the switchable element to switch the switchable element to a second state; wherein the switchable element is configured, when switched to the first state by the first bias voltage, to output a first output voltage having a first random or pseudorandom voltage value from a first range of voltage values; and wherein the switchable element is configured, when switched to the second state by the second bias voltage, to output a second output voltage having a second random or pseudorandom voltage value from a second range of voltage values. And:
outputting a first numerical value if the first output voltage from the first range of values is smaller than or equal to a first threshold voltage; or outputting a second numerical value different from the first numerical value if the first output voltage from the first range of values is greater than the first threshold voltage.
Or: outputting the second numerical value if the first output voltage from the first range of values is smaller than or equal to a first threshold voltage; or outputting the first numerical value if the first output voltage from the first range of values is greater than the first threshold voltage.

Furthermore, a computer program having program code for performing the above-described method according to an embodiment is provided.

### BRIEF DESCRIPTION OF THE DRAWINGS

Embodiments of the invention will be described below with reference to the drawings, in which:

FIG. 1 shows an apparatus for generating a sequence of random numbers according to an embodiment;

FIG. 2 shows the current-voltage characteristics of a single cell of a memristive device based on YMO (yttrium manganese oxide) according to an embodiment;

FIG. 3 shows the cycle-to-cycle variation of SET and RESET bias voltages in both positive and negative switching directions of a single YMO memristor cell according to an embodiment;

FIG. 4 shows a YMO memristor cell-based basic element for a true random number generator which can be used for as a cryptographic key; and

FIG. 5 shows the distribution of the pulse amplitude of a single YMO memristor cell with 100 cycles as a function of the pulse width.

### DETAILED DESCRIPTION OF THE INVENTION

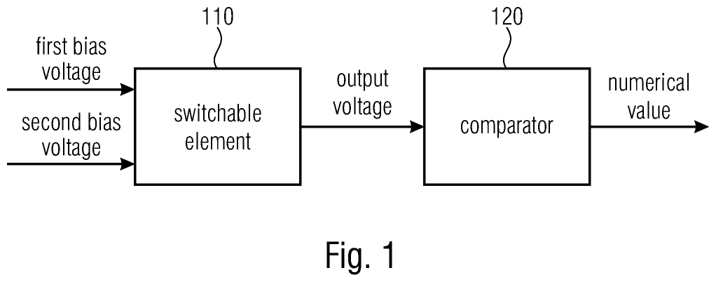

FIG. 1 shows an apparatus for generating a sequence of random numbers according to an embodiment.

The apparatus includes a switchable element 110 switchable to a first state by applying a first bias voltage, and switchable to a second state by applying a second bias voltage different from the first bias voltage.

The switchable element 110 is configured, when switched to the first state by the first bias voltage, to output a first output voltage having a first random or pseudorandom voltage value from a first range of voltage values.

Furthermore, when switched to the second state by the second bias voltage, the switchable element 110 is configured to output a second output voltage having a second random or pseudorandom voltage value from a second range of voltage values.

Additionally, the apparatus comprises a comparator 120 configured to output a first numerical value, if the first output voltage from the first range of values is smaller than or equal to a first threshold voltage; and if the first output voltage from the first range of values is greater than the first threshold voltage, a second numerical value different from the first numerical value.

Furthermore, if the second output voltage from the second range of values is smaller than or equal to a second threshold voltage, the comparator 120 is configured to output the first numerical value, and if the second output voltage from the second range of values is greater than the second threshold voltage, the comparator 120 is configured to output the second numerical value.

Or else the comparator 120 is configured to output the second numerical value if the second output voltage from the second range of values is smaller than or equal to a second threshold voltage, and to output the first numerical value if the second output voltage from the second range of values is greater than the second threshold voltage.

According to an embodiment, the comparator 120 may be configured, for example, to output the first numerical value or the second numerical value as a first output value in a first output step. Thus, the apparatus may, for example, be configured to apply either the first bias voltage or the second bias voltage to the switchable element 110 depending on whether the comparator 120 outputs the first numerical value or the second numerical value. Thus, the switchable element 110 may be configured, for example, to output a further output voltage having a random or pseudo-random voltage value, depending on whether the first bias voltage or the second bias voltage has been applied, from the first range of voltage values or from the second range of voltage values. Furthermore, the comparator 120 may be configured to output, for example, as a second output value, in a second output step, the first numerical value or the second numerical value depending on the further output voltage.

In one embodiment, the apparatus may further comprise, for example, a multiplexer which may be configured to apply either the first bias voltage or the second bias voltage to the switchable element 110 depending on whether the comparator 120 outputs the first numerical value or the second numerical value.

According to an embodiment, the switchable element 110 may be, for example, a memristor.

In one embodiment, the switchable element 110 may comprise, for example, yttrium manganese oxide.

According to an embodiment, the switchable element 110 may comprise, for example, bismuth ferrite and/or, for example, bismuth ferrite doped with titanium.

In one embodiment, for example, a largest absolute value of the first range of voltage values may be at least twice as large as a largest absolute value of the second range of voltage values, or the largest absolute value of the second range of voltage values may be at least twice as large as the largest absolute value of the first range of voltage values, for example.

According to an embodiment, the largest absolute value of the first range of voltage values may be, for example, at least four times as large as the largest absolute value of the second range of voltage values, or the largest absolute value of the second range of voltage values may be, for example, at least four times as large as the largest absolute value of the first range of voltage values.

In one embodiment, the second threshold voltage may be different from the first threshold voltage, for example.

According to an embodiment, the first threshold voltage may be defined, for example, such that a statistical probability that the first output voltage having the first random or pseudorandom voltage value is greater than the first threshold voltage has a value between 45% and 55%, and/or the second threshold voltage may be defined, for example, such that a statistical probability that the second output voltage having the second random or pseudorandom voltage value is greater than the second threshold voltage has a value between 45% and 55%.

In one embodiment, the first threshold voltage may be set such that, for example, the statistical probability that the first output voltage having the first random or pseudorandom voltage value is greater than the first threshold voltage is 50%, and/or the second threshold voltage may be set such that, for example, the statistical probability that the second output voltage having the second random or pseudorandom voltage value is greater than the first threshold voltage is 50%.

According to an embodiment, the sequence of random numbers may be, for example, a binary sequence of random numbers. Here, for example, an output of the first numerical value or the second numerical value by the comparator 120 may correspond to exactly one random number of the binary sequence of random numbers.

For example, in one embodiment, the sequence of random numbers is not a binary sequence of random numbers. Here, the apparatus may be configured, for example, to form a random number of the sequence of random numbers using several numerical values output by the comparator 120.

According to an embodiment, the apparatus may be configured, for example, to form said random number of the sequence of random numbers using said several numerical values output by the comparator 120 by having each of said several numerical values form exactly one binary digit of said random number of the sequence of random numbers in binary notation.

In one embodiment, for example, the apparatus may include a current conformity unit which applies a predefined input current to the switchable element 110 when the first bias voltage is applied.

According to an embodiment, the apparatus may have, for example, two or more memristors.

In one embodiment, the plurality of memristors may be arranged in series, for example, and/or the plurality of memristors may be arranged in parallel in a line array, for example, and/or the plurality of memristors may be arranged in a crossbar array, for example.

According to an embodiment, the switchable element 110 may be, for example, a first switchable element 110 and the comparator 120 may be, for example, a first comparator. Thus, the apparatus may further comprise, for example, a further switchable element 110 and, for example, a further comparator to generate random numbers of the sequence of random numbers.

The actual polarity and amplitude of the applied write bias voltage are determined by the potential of the upper electrode (T1) and the lower electrode (T2) of the resistive switch. For example, the upper electrode (T1) can be considered to be a reference for the bias voltage applied to the device. If the potential of the upper electrode is higher than that of the lower electrode, this can be considered to be a positive voltage applied to the device. Otherwise, if the potential of the lower electrode is higher, this can be considered to be a negative voltage applied to the device.

It should be noted that if the upper electrode and the lower electrode have the same potential, there is no potential difference at the device, i.e. no actual voltage would be present at the device.

Embodiments provide one or more switchable elements, e.g., one or more memristive devices (one or more memristors), for random number generators (RNG). In embodiments, the operation of such memristive devices is realized as a true random number generator (TRNG) and as a sequence of numbers generator (SNG).

In embodiments, a switchable element, e.g., a memristive device (a memristor), is provided in a single cell, line, or array design in which the current-voltage (IV) characteristic of each cell varies randomly. According to an embodiment, the distribution of responses (output), for example of a read current, when “challenges” (input) of a read voltage are queried, for example, may be distributed in a box-like manner around a probability threshold value, which may be specific to each cell of the memristive device in single cell, line or array design.

In some embodiments, the probability of the 0/1 bit stream may be determined by a probability threshold value, for example. If the probability of the 0/1 bit stream is 50%:50%, the RNG may be used as a TRNG, for example for key exchange. With a random choice of the probability of the 0/1 bit stream, the RNG can be used as an SNG, for example for stochastic computing.

In some embodiments, providing random bit streams using memristive devices with strict hardware and power constraints can be used for efficient key exchange and for efficiently computing data-intensive problems. The use of a memristive device to build TRNGs and SNGs based on an electroforming-free memristor provides an efficient design which significantly reduces the relative costs.

Reliable operation of the RNG under extreme temperatures can be ensured, for example, by comparably changing the IV characteristics of all the cells of the memristive device in single cell, line, or array designs.

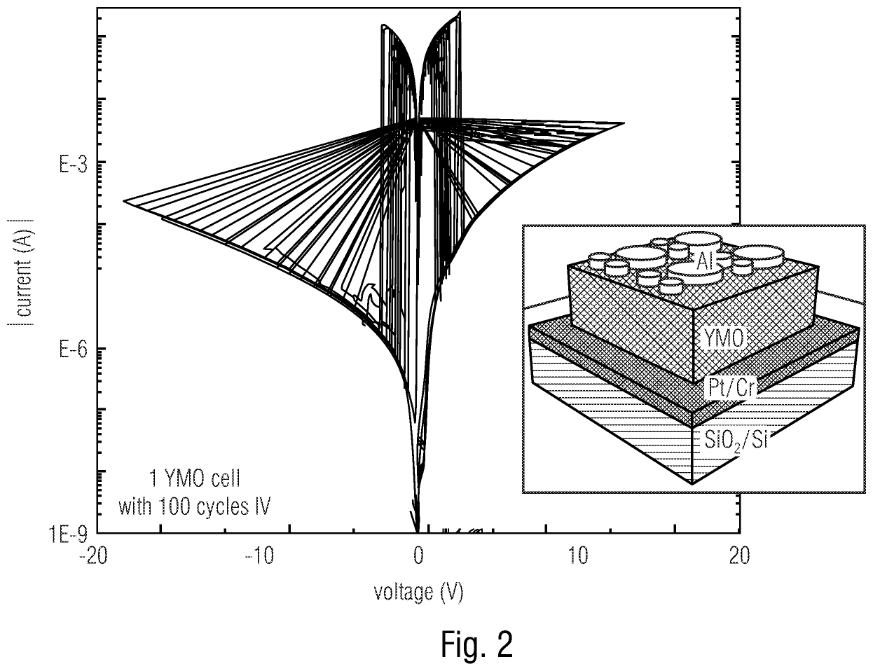

FIG. 2 shows current-voltage characteristics (referred to as I-V characteristics or IV characteristics) and statistical results in YMO (yttrium manganese oxide), in particular, the experimental current-voltage (I-V) characteristics of the YMO memristors with the corresponding schematic images of the memristor stacks.

In particular, FIG. 2 shows the IV characteristics of a single cell of a YMO-based memristive device at semilog scale with 100 cycles in both positive and negative ramp voltage directions.

For example, in FIG. 2, the sizes of the top contact area are 0.1 mm², the pulse width tp is tp=10 ms, and the current compliance (CC) for the SET process is 10 mA. The inset schematically illustrates the memristive device.

In the exemplary YMO-based memristive device of FIG. 2, the SET and RESET voltages have the same polarity but different amplitudes.

In one embodiment, for example, current compliance (CC) is used during the switching process to prevent permanent failure of the device.

Successive switching cycles of a single cell of a YMO-based memristive device (FIG. 2) show obvious cycle-to-cycle variations in SET and RESET bias voltages in both positive and negative switching directions, confirming the stochastic nature of their switching behavior.

Memristive devices with a random variation of IV characteristics can be used to realize RNGs.

Statistical results in the memristive YMO device show that the randomness of the distribution of the SET and RESET switching voltages in both positive and negative bias directions can be used to generate 0/1 bit streams.

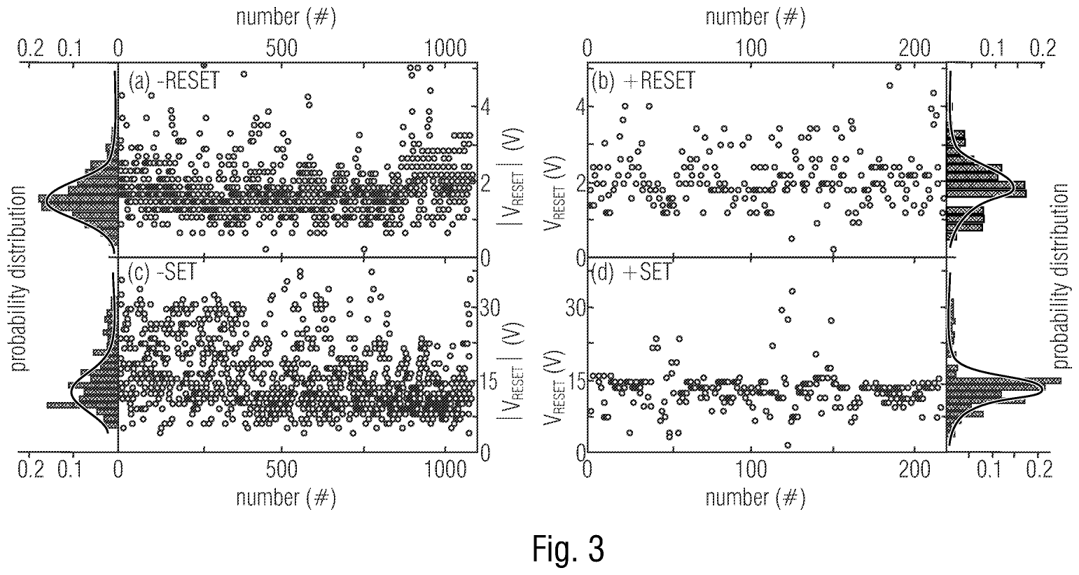

FIG. 3 shows in (a) a distribution of the switching bias voltages of a cell of a YMO-based memristive device during
(a) RESET in negative voltage direction,
(b) RESET in positive voltage direction,
(c) SET in negative voltage direction, and
(d) SET in positive voltage direction
   with 225 cycles in positive bias direction and 1082 cycles in negative bias direction (bias direction).

In FIG. 3, the current conformity for the SET process in the YMO memristive device (memristor) is 10 mA, for example. The size of the upper contact area is 0.1 mm². The pulse width is tp=10 ms. The insets show the corresponding histograms.

For example, FIG. 3 shows the cycle-to-cycle variation of SET and RESET bias voltages in both positive (225 cycles) and negative (1082 cycles) switching directions of a single YMO memristor cell. The width of the distribution was modeled using a Gaussian function with a large half-value width.

Further specific embodiments are described below.

In a particular embodiment, a single cell of a YMO-based memristive device is provided for realizing a TRNG. The SET and RESET distortions with a cumulative probability of 50% are selected as source distortions in the block design of TRNG as V_{SET} and V_{RESET} for receiving the Hamming distance between the classes of 50%.

In one embodiment, operation of YMO-based memristive devices may be provided as TRNG and SNG. For example, both stochastic and secure properties may be used for a TRNG. For example, an excellent autocorrelation for maintaining secrecy results. Due to the purely stochastic distribution of switching devices in YMO membrane cells during SET and RESET processes, the YMO membrane cell is provided as a random source for the TRNG design, for example.

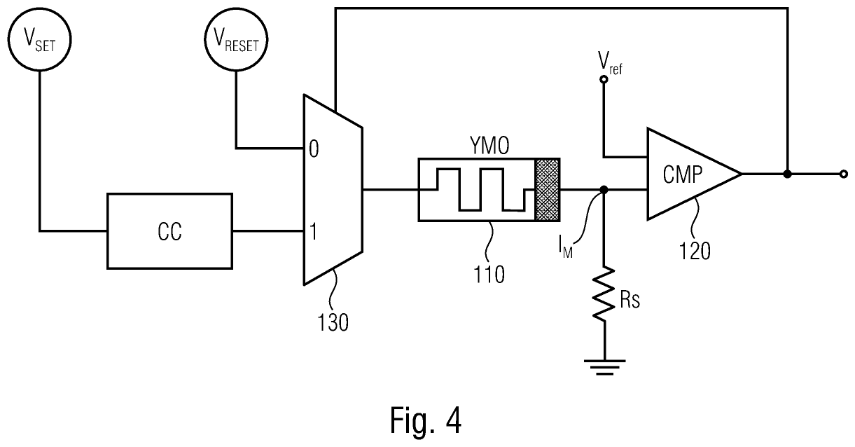

FIG. 4 shows a YMO-based memristive device for a true random number generator. For example, the random number generator can be used for a cryptographic key. Furthermore, FIG. 4 exemplifies the mode of functioning of a YMO as a TRNG using a specific example.

In embodiments, the setup of FIG. 4 does not require a read bias voltage.

FIG. 4 particularly shows a YMO memristor cell 110, a multiplexer 130, a comparator 120, and a current compliance unit (also referred to as CC unit).

A SET bias voltage V_{SET} of fixed width is applied to a YMO memristor cell 110 and to a series resistor Rs.

When under the applied (bias) voltage the YMO memristor cell 110 is turned on and thus the output voltage across the series resistor Rs is Icc·Rs, which is higher than the well-defined reference voltage of the comparator 120 V_{ref}, the output voltage of the comparator goes to the high logic level, therefore the output of the comparator 120 is “logic-1”.

Icc is the matching level current of the YMO device. For the reference voltage V_{ref} of the comparator 120, V_{ref}=Icc·RS-V_{OFFSET}. V_{OFFSET} has a small constant value, e.g. 0.001 V, which is not related to the dynamics of YMO cells.

In the next switching cycle, V_{RESET} corresponding to feedback “1” from the output of comparator 120 in the previous cycle is selected by the multiplexer 130 and applied to the YMO memristor cell 110 to reset the cell to HRS. Thus, the voltages VRs in HRS are lower than V_{ref}. The output of comparator 120 in this case is “logic-0”.

In one embodiment, to achieve uniformity (50% probability of LRS/HRS), the pulse width and amplitude of the SET/RESET processes are set based on a statistical examination.

Compared to existing memristor-based TRNGs, advantages of the exemplary apparatus of FIG. 4 for the YMO-based analog interface block TRNG can be described as follows:

First, no additional SET/RESET bias voltage is required to generate a random bit. In previous devices, a pair of SET and RESET pulses was used to generate each random bit due to the non-volatility of a memristive device based on Cu/AlOx and Ti/HfOx (see [15], [16]). Such a disadvantage results in a low bit rate of TRNGs. The exemplary apparatus of FIG. 4 solves this problem by efficiently exploiting the natural stochastic distribution of SET and RESET biases during switching operations. Therefore, every single SET or RESET bias can generate a random bit by YMO TRNG.

Second, no additional read bias voltage is required during the process. The random bits are generated based on the comparison between the voltage across Rs (VRs=IM·Rs) and the reference voltage (V_{ref}=Icc·Rs-V0).

Third, the definition of the reference voltage can be kept constant. In the proposed YMO-based TRNG, the definition of V_{ref} is not related to the switching bias voltage of YMO cells. It is clearly defined to be V_{ref}=Icc·Rs-V0, which is convenient for the large-scale design of TRNG.

CMOS-based stochastic circuits consist of SNG conversion sources and arithmetic logic gates. SNGs are essential components for memristive implementations of SC circuits. The high resource consumption of conventional SNGs developed in CMOS technology is reduced, for example, by the exemplary apparatus of FIG. 4. The inherently stochastic YMO memristor cells are proposed here to realize the low-cost SNG.

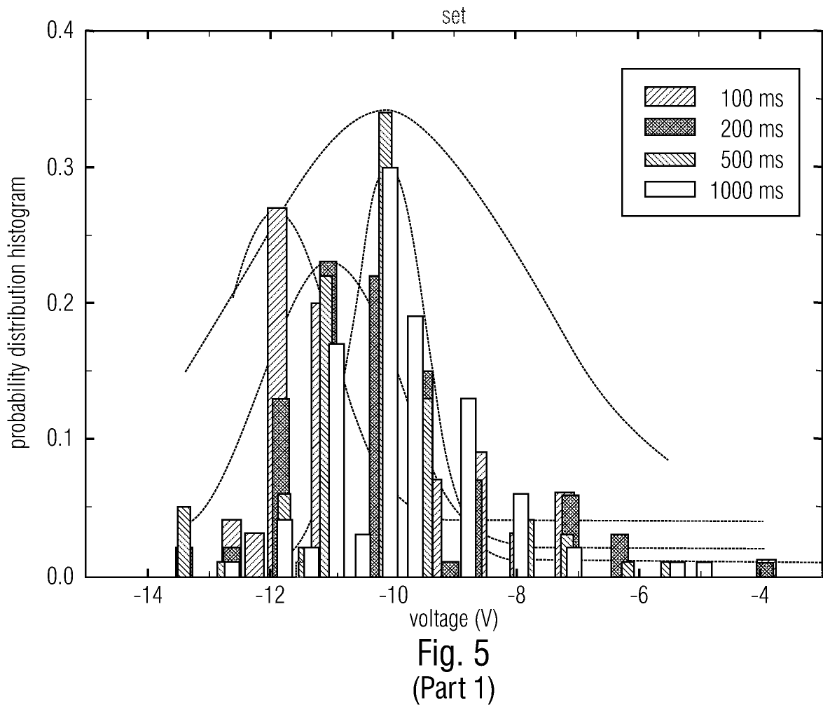

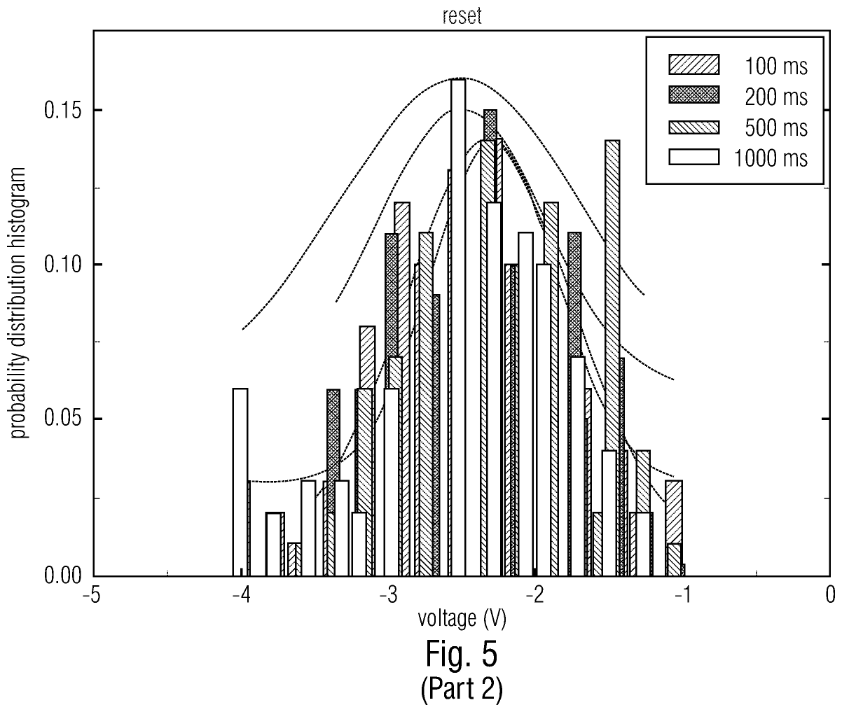

FIG. 5 shows the distribution of the pulse amplitude of a single YMO memristor cell with 100 cycles as a function of the pulse width (100 ms, 200 ms, 500 ms, 1000 ms) in SET and RESET. A Poisson distribution with a large half-value width is observed, and its mean value shifts to smaller voltages for SET with an increasing pulse width. Thus, when setting the SET voltage, the 0/1 probability distribution can be set via the pulse width ([13-14]).

As is shown in FIG. 5, the stochastic switching behavior of the YMO-based memristor cell is controllable, i.e., with different pulse widths or pulse amplitudes, the output can be realized with probabilities. By using this switching time dependence of YMO-based memristive devices (FIG. 5), it is helpful to construct SNG from TRNG in FIG. 4 for SC.

Further embodiments of the invention are described below.

In one embodiment, for example, a Sequence Number Generator (SNG) implementation having a single, electroforming-free, unipolar memristor without an electroforming step can be realized.

According to an embodiment, for example, the memristor may have a stochastic current-voltage characteristic, that is the read current Ir may be randomly below or above a threshold value for a given write voltage Uw, write pulse length tw, and read voltage Ur, for example.

For example, in one embodiment, the memristor can show the stochastic current-voltage characteristic, such as for positive write voltages, for negative write voltages, for write voltages which place the memristor in the high resistance state (HRS) (Ur=URESET), and for write voltages which place the memristor in the low resistance state (LRS) (Ur=USET).

According to an embodiment, for example, the reference value for the memristor may be fixed.

For example, in one embodiment, the write pulse length tp may determine the probability of the sequence number generator (SNG) as a function of the write voltage, (negative, positive, URESET, USET).

According to an embodiment, for example, the write pulse length may be internally randomly selected, and thus, for example, the probability of the sequence number generator may be randomly selected.

For example, in one embodiment, a realization of several (N) sequence number generators (SNGs) with several (N) electroforming-free unipolar memristors can be performed without an electroforming step.

According to an embodiment, for example, the (N) memristors of the (N) sequence number generators (SNG) may be implemented with a common unstructured or a structured back-side electrode and may be arranged in series or in series and/or in parallel in a line array or in a crossbar array.

In one embodiment, for example, each of the N memristors may have a stochastic current-voltage characteristic, wherein, for example, the read current Ir may be randomly below or above a threshold value for a given write voltage Uw, write pulse length tw and read voltage Ur.

According to an embodiment, for example, each of the N memristors can show the stochastic current-voltage characteristic, for example, for positive write voltages, for negative write voltages, for write voltages which put the memristor in the high resistance state (HRS) (Ur=URESET), and for write voltages which put the memristor in the low resistance state (LRS) (Ur=USET).

In one embodiment, for example, (N) reference values may be set for each of the (N) memristors.

According to an embodiment, for example, the write pulse length tp of each of the (N) memristors may determine the probability of the sequence number generator (SNG) of each of the (N) memristors as a function of the write voltage Uw (negative, positive, URESET, USET).

For example, in one embodiment, the write pulse length tp of each of the (N) memristors may be internally randomly selected, wherein the probability of the sequence number generator of each of the (N) memristors can be randomly selected.

Key exchange can be shown as an application example, for example. For example, a true random number generator with a threshold value of 50:50 can be used for this.

Stochastic computing with a sequence number generator can be provided as a further application example, for example.

Although some aspects have been described in the context of an apparatus, it is understood that these aspects also represent a description of the corresponding method so that a block or component of an apparatus is also to be understood to be a corresponding method step or feature of a method step. Similarly, aspects described in connection with or as a method step also constitute a description of a corresponding block or detail or feature of a corresponding apparatus. Some or all of the method steps may be performed by (or using) a hardware apparatus, such as a microprocessor, a programmable computer, or an electronic circuit. In some embodiments, some or several of the most important method steps may be performed by such an apparatus.

Depending on particular implementation requirements, embodiments of the invention may be implemented in hardware or in software, or at least partially in hardware or at least partially in software. The implementation may be performed using a digital storage medium, for example, a floppy disk, a DVD, a BluRay disc, a CD, ROM, PROM, EPROM, EEPROM, or a FLASH memory, a hard disk drive, or any other magnetic or optical storage on which electronically readable control signals are stored which can or do cooperate with a programmable computer system such that the respective method will be performed. Therefore, the digital storage medium may be computer-readable.

Thus, some embodiments according to the invention include a data carrier having electronically readable control signals capable of cooperating with a programmable computer system such that any of the methods described herein will be performed.

Generally, embodiments of the present invention may be implemented as a computer program product having program code, the program code operative to perform any of the methods when the computer program product runs on a computer.

For example, the program code may also be stored on a machine-readable medium.

Other embodiments comprise the computer program for performing any of the methods described herein, wherein the computer program is stored on a machine-readable medium. In other words, an embodiment of the method according to the invention is thus a computer program comprising program code for performing any of the methods described herein when the computer program runs on a computer.

Thus, a further embodiment of the methods of the invention is a data carrier (or digital storage medium or computer-readable medium) having recorded thereon the computer program for performing any of the methods described. The data carrier or digital storage medium or computer-readable medium is typically tangible and/or non-volatile.

Thus, a further embodiment of the method according to the invention is a data stream or sequence of signals representing the computer program for performing any of the methods described herein. The data stream or sequence of signals may, for example, be configured to be transferred via a data communication link, for example via the Internet.

Another embodiment comprises processing means, such as a computer or programmable logic device, configured or adapted to perform any of the methods described herein.

Another embodiment includes a computer having installed thereon the computer program for performing any of the methods described herein.

Another embodiment according to the invention comprises an apparatus or system configured to transmit a computer program for performing at least one of the methods described herein to a receiver. The transmission may be, for example, electronic or optical. The receiver may be, for example, a computer, mobile device, storage device, or similar device. The apparatus or system may include, for example, a file server for transmitting the computer program to the receiver.

In some embodiments, a programmable logic device (for example, a field programmable gate array, FPGA) may be used to perform some or all of the functionalities of the methods described herein. In some embodiments, a field programmable gate array may cooperate with a microprocessor to perform any of the methods described herein. Generally, in some embodiments, the methods are performed on the part of any hardware apparatus. This may be general-purpose hardware, such as a computer processor (CPU), or hardware specific to the method, such as an ASIC.

While this invention has been described in terms of several advantageous embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

### BIBLIOGRAPHY

[1] D. Evans. The internet of things: how the next evolution of the internet is changing everything. Cisco 1-11 (2011).
[2] M. Bucci, L. Germani, R. Luzzi, A. Trifiletti, & M. aranonuovo. A high-speed oscillator-based truly random number source for cryptographic applications on a smart card IC. IEEE Trans. Computers, 52: 403-409 (2003).
[3] C. S. Petrie, J. A. Connelly. A noise-based IC random number generator for applications in cryptography. IEEE Trans. Circuits and Systems I., 47: 615-621 (2002).
[4] C. Tokunaga, D. Blaauw, T. Mudge, True random number generator with a metastability-based quality control. IEEE Journal of Solid-State Circuits (Proc. ISSCC), 43: 78-85 (2008).
[5] A. G. Radwan, M. A. Zidan, K. N. Salama, “HP memristor mathematical model for periodic signals and DC,” IEEE International Midwest Symposium on Circuits and Systems, Seattle, USA, 861-864 (2010).
[6] C. Y. Huang, W. C. Shen, Y. H. Tseng, Y. C. King, & C. J. Lin. A contact resistive random-access-memory-based true random number generator. IEEE Electron Devices Lett, 33: 1108-1110 (2012).
[7] S. Ambrogio, S. Balatti, V. McCaffrey, D. Wang, and D. Ielmini. Im-Pact of low-frequency noise on read distributions of resistive switching memory (RRAM). In IEDM Tech. Dig. pp. 363-366, 14.4, (2014).
[8] S. Balatti, S. Ambrogio, Z. Wang, D. Ielmini. True random number generation by variability of resistive switching in oxide-based devices. IEEE J. Emerg. Select. Top. Circuits Syst. 5, 214-221 (2015).
[9] S. Balatti, et al, “Physical unbiased generation of random numbers with coupled resistive switching devices. IEEE Transac,” Electron Devices 63, 2029-2035 (2016).
[10] A. Rukhin et al. A statistical test suite for random and pseudorandom number generators for cryptographic applications. NIST, Special Publication: 800-822, (2010).
[11] Z. Wei, et al. True random number generator using current difference based on a fractional stochastic model in 40-nm embedded ReRAM. IEEE Electron. Dev. Meet. 4.8.1-4.8.4 (San Francisco, Calif., USA, 2016).
[12] A. Alaghi, and J. P. Hayes. Survey of stochastic computing. ACM Trans. Embed. Comput. Syst., vol. 12, no. 2s, pp. 92:1-92:19, May (2013).
[13] S. Jo, K. Kim, and W. Lu, “Programmable resistance switching in nanoscale two-terminal devices,” Nano Lett, vol. 9, no. 1, 496-500 (2008).
[14] D. Strukov, J. Borghetti, and R. Williams, “Coupled ionic and electronic transport model of thin-film semiconductor memristive behavior,” Small, vol. 5, no. 9, 1058-1063 (2009).
[15] S. Balatti, et al, “Physical unbiased generation of random numbers with coupled resistive switching devices. IEEE Transac,” Electron Devices 63, 2029-2035 (2016).
[16] A. Rukhin, et al, “A statistical test suite for random and pseudorandom number generators for cryptographic applications”, NIST, Special Publication 800-822, (2010).

1. An apparatus for generating a sequence of random numbers, the apparatus comprising:
a switchable element switchable to a first state by applying a first bias voltage, and switchable to a second state by applying a second bias voltage different from the first bias voltage; wherein the switchable element is configured, when switched to the first state by the first bias voltage, to output a first output voltage comprising a first random or pseudorandom voltage value from a first range of voltage values and wherein the switchable element is configured, when switched to the second state by the second bias voltage, to output a second output voltage comprising a second random or pseudorandom voltage value from a second range of voltage values; and
a comparator configured to output, if the first output voltage from the first range of values is smaller than or equal to a first threshold voltage, a first numerical value; and output, if the first output voltage from the first range of values is greater than the first threshold voltage, a second numerical value different from the first numerical value;
wherein the comparator is configured,
if the second output voltage from the second range of value is smaller than or equal to a second threshold voltage, to output the first numerical value, and if the second output voltage from the second range of values is greater than the second threshold voltage, to output the second numerical value; or
if the second output voltage from the second range of values is smaller than or equal to a second threshold voltage, to output the second numerical value, and if the second output voltage from the second range of values is greater than the second threshold voltage, to output the first numerical value.

2. The apparatus according to claim 1,
wherein the comparator is configured to output, in a first output step, the first numerical value or the second numerical value as a first output value,
wherein the apparatus is configured to apply either the first bias voltage or the second bias voltage to the switchable element depending on whether the comparator outputs the first numerical value or the second numerical value,
wherein the switchable element is configured to output a further output voltage comprising a random or pseudo-random voltage value, depending on whether the first bias voltage or the second bias voltage has been applied, from the first range of voltage values or from the second range of voltage values, and
wherein the comparator is configured to output, in a second output step, as a second output value, the first numerical value or the second numerical value depending on the further output voltage.

3. The apparatus according to claim 2,
wherein the apparatus further comprises a multiplexer configured to apply either the first bias voltage or the second bias voltage to the switchable element depending on whether the comparator outputs the first numerical value or the second numerical value.

4. The apparatus according to claim 1,
wherein the switchable element is a memristor.

5. The apparatus according to claim 1,
wherein the switchable element comprises yttrium manganese oxide.

6. The apparatus according to claim 1,
wherein the switchable element comprises bismuth ferrite and/or titanium-doped bismuth ferrite.

7. The apparatus according to claim 1,
wherein a largest absolute value of the first range of voltage values is at least twice as large as a largest absolute value of the second range of voltage values, or
wherein the largest absolute value of the second range of voltage values is at least twice as large as the largest absolute value of the first range of voltage values.

8. The apparatus according to claim 7,
wherein the largest absolute value of the first range of voltage values is at least four times as large as the largest absolute value of the second range of voltage values, or
wherein the largest absolute value of the second range of voltage values is at least four times as large as the largest absolute value of the first range of voltage values.

9. The apparatus according to claim 1,
wherein the second threshold voltage is different from the first threshold voltage.

10. The apparatus according to claim 1,
wherein the first threshold voltage is defined such that a statistical probability that the first output voltage comprising the first random or pseudorandom voltage value is greater than the first threshold voltage comprises a value between 45% and 55%, and/or
wherein the second threshold voltage is defined such that a statistical probability that the second output voltage comprising the second random or pseudorandom voltage value is greater than the second threshold voltage comprises a value between 45% and 55%.

11. The apparatus according to claim 10,
wherein the first threshold voltage is set such that the statistical probability that the first output voltage comprising the first random or pseudorandom voltage value is greater than the first threshold voltage is 50%, and/or
wherein the second threshold voltage is set such that the statistical probability that the second output voltage comprising the second random or pseudorandom voltage value is greater than the first threshold voltage is 50%.

12. The apparatus according to claim 1,
wherein the sequence of random numbers is a binary sequence of random numbers,
wherein an output of the first numerical value or the second numerical value from the comparator corresponds to exactly one random number of the binary sequence of random numbers.

13. The apparatus according to claim 1,
wherein the apparatus is configured to form a random number of the sequence of random numbers using several numerical values output from the comparator.

14. The apparatus according to claim 13,
wherein the apparatus is configured to form said random number of the sequence of random numbers using said several numerical values output from the comparator by having each of said several numerical values form exactly one binary digit of said random number of the sequence of random numbers in binary notation.

15. The apparatus according to claim 1,
wherein the apparatus comprises a current conformity unit which applies a predefined input current to the switchable element when the first bias voltage is applied.

16. The apparatus according to claim 1,
wherein the apparatus comprises two or more memristors.

17. The apparatus according to claim 16,
wherein the plurality of memristors are arranged in series, and/or
wherein the plurality of memristors are arranged in parallel in a line array, and/or
wherein the plurality of memristors are arranged in a crossbar array.

18. The apparatus according to claim 1,
wherein the switchable element is a first switchable element,
wherein the comparator is a first comparator, and
wherein the apparatus further comprises a further switchable element and a further comparator to generate random numbers of the sequence of random numbers.

19. A method for generating a sequence of random numbers, the method comprising:
applying a first bias voltage to a switchable element to switch the switchable element to a first state, or applying a second bias voltage, different from the first bias voltage, to the switchable element to switch the switchable element to a second state; wherein the switchable element is configured, when switched to the first state by the first bias voltage, to output a first output voltage comprising a first random or pseudorandom voltage value from a first range of voltage values; and wherein the switchable element is configured, when switched to the second state by the second bias voltage, to output a second output voltage comprising a second random or pseudorandom voltage value from a second range of voltage values; and
outputting a first numerical value if the first output voltage from the first range of values is smaller than or equal to a first threshold voltage; or outputting a second numerical value, different from the first numerical value, if the first output voltage from the first range of values is greater than the first threshold voltage; or
outputting the second numerical value if the first output voltage from the first range of values is smaller than or equal to a first threshold voltage; or outputting the first numerical value if the first output voltage from the first range of values is greater than the first threshold voltage.

20. A non-transitory digital storage medium having stored thereon a computer program for performing a method for generating a sequence of random numbers, the method comprising:
applying a first bias voltage to a switchable element to switch the switchable element to a first state, or applying a second bias voltage, different from the first bias voltage, to the switchable element to switch the switchable element to a second state; wherein the switchable element is configured, when switched to the first state by the first bias voltage, to output a first output voltage comprising a first random or pseudorandom voltage value from a first range of voltage values; and wherein the switchable element is configured, when switched to the second state by the second bias voltage, to output a second output voltage comprising a second random or pseudorandom voltage value from a second range of voltage values; and
outputting a first numerical value if the first output voltage from the first range of values is smaller than or equal to a first threshold voltage; or outputting a second numerical value, different from the first numerical value, if the first output voltage from the first range of values is greater than the first threshold voltage; or
outputting the second numerical value if the first output voltage from the first range of values is smaller than or equal to a first threshold voltage; or outputting the first numerical value if the first output voltage from the first range of values is greater than the first threshold voltage,
when said computer program is run by a computer.
